(19) United States
(12) Patent Application Publication
(10) Pub. No.: US 2008/0011383 A1
(43) Pub. Date: Jan. 17, 2008

(54) Fireproof hose

(76) Inventors: Mario Paetow, Igling (DE); Herbert Muenzenberger, Wiesbaden (DE); Christian Foerg, Dillishausen (DE)

Correspondence Address: ABELMAN, FRAYNE & SCHWAB, 666 THIRD AVENUE, 10TH FLOOR, NEW YORK, NY, 10017, US

(21) Appl. No.: 11/788,290

(22) Filed: Apr. 18, 2007

(30) Foreign Application Priority Data
Apr. 20, 2006 (DE) 10 2006 000 189.3

(51) Int. Cl. F16L 11/12

(52) U.S. Cl. 138/177

(57) ABSTRACT

A fireproof hose (10) for passing conduits or cables through a constructional element is formed at least partially of an elastic and intumescent material and has a shaped profile provided on at least one of the outer surface (11) and the inner surface of the hose.

### BACKGROUND OF THE INVENTION

1. Field of the Invention

The present invention relates to a fireproof hose for passing conduits or cables through a constructional element and formed at least partially of an elastic and intumescent material and having outer surface and inner surface extending in a longitudinal direction.

2. Description of the Prior Art

As mentioned above, the fireproof hose of the type discussed above is used for passing a conduit or a cable through a constructional element, e.g., through a ceiling or a wall.

European Publication EP 1 396 675 A1 discloses a fireproof hose the main component of which is thermally expandable graphite, thermally expandable rubber, or thermally expandable resin. The fireproof hose is slotted in a longitudinal direction in order to be able subsequently put it around a conduit. The upper surface of this fireproof hose is smooth.

The drawback of the fireproof hose disclosed in EP 1 396 675 A1 consists in that in case of fire, it has, at its end remote from the fire center, only a small cooling effect and can be used primarily for a thermal isolation of a sheathable conduit having a relatively large thickness.

Accordingly, an object of the present invention is to provide a fireproof hose for passing conduits through constructional elements in which the drawback of the known hose is eliminated.

Another object of the present invention is to provide a fireproof hose of the type described above and having good isolating characteristics.

### SUMMARY OF THE INVENTION

These and other objects of the present invention, which will become apparent hereinafter, are achieved by providing a profile on least one of the outer and inner surface of the hose.

The profile increases the physically active surface of the fireproof hose and improves the heat exchange with the environment. Thereby, a better cooling effect is achieved at the end of the hose remote from the fire center. Further, the improve heat exchange reduces the reaction time of the intumescent material. Still further, the profile increases the thickness of the hose material, thus, improving the thermal isolating characteristics, without a need to use correspondingly more material.

It is advantageous, when the profile is formed by a plurality of ribs extending in a longitudinal direction. When the fireproof hose is mounted in a hole in a constructional element, such as e.g., a wall, the ribs provide for an easier deformation of the fireproof hose, so that the hose can be inserted in holes or bores the diameter of which is smaller than the diameter of the fireproof hose. Here, with a deviation of the hole diameter, the tolerance region lies within several mm.

It is advantageous when the ribs are equidistantly spaced from each other and extend parallel to each other, which insure a uniform distribution of the ribs over the surface. This provides for uniform thermal and physical characteristics of the entire fireproof hose.

Advantageously, the ribs are provided on the outer surface of the fireproof hose. Thereby in addition to a positive thermal effect, there is provided a possibility for engagement of adjacent fireproof hoses with each other, with ribs of one hose engaging in respective grooves of an adjacent hose and vice versa. Thereby, groups or clusters of fireproof hoses can be formed which together can be mounted in a large opening or hole formed in a constructional element.

It is also advantageous when the ribs are formed on the inner surface of a fireproof hose. Thereby, in case of fire, a hot metal core of a cable, which extends through the hose, is held at a distance from the hose outer surface, which prevents collapsing of the material of the fireproof hose as it becomes weaker. The outer surface remains cooler as the contact with the hot copper core is prevented. Thereby, a more efficient isolation effect is achieved.

Advantageously, the ribs are provided on both the outer and inner surfaces of the fireproof hose. Thereby, a combined effect of providing ribs on the outer and inner surfaces is achieved.

A tooth-shaped formation of the ribs improves the above described possibility to combine fireproof hoses in groups or clusters, as tooth-shaped ribs can optimally engage with each other, in the same way as teeth of tooth gears engage each other.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a cross-sectional view of a bundle of fireproof hoses according to the present invention;

FIG. 2 a side view of a single fireproof hose shown in FIG. 1;

FIG. 3 a cross-sectional view of another embodiment of a fireproof hose according to the present invention; and

FIG. 4 a cross-sectional view of a still further embodiment of a fireproof hose according to the present invention.

### DETAILED DESCRIPTION OF THE PREFERRED EMBODIMENTS

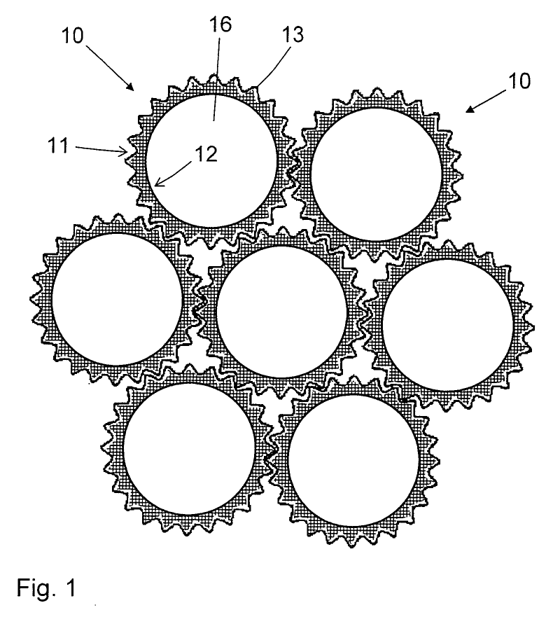

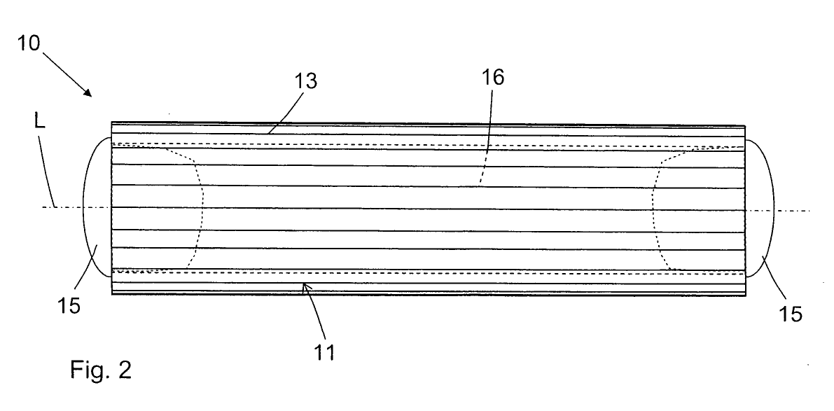

A fireproof hose 10 according to the present invention, a first embodiment of which is shown in FIGS. 1-2, is formed as an elastic body extending in a longitudinal direction L and formed of, e.g., a rubber-elastic material such as, e.g., rubber-like polymer with intumescent properties. As an intumescent component, an expandable graphite, e.g., or similar known intumescent material can be used.

On the outer surface 11 of the fireproof hose 10, there is formed a profile in form a plurality of first ribs 13 extending parallel to each other in the longitudinal direction L of the fireproof hose 10 and having, in the embodiment shown in FIGS. 1-2, a tooth-shaped triangular cross-section. The first ribs 13 improve thermal characteristics of the fireproof hose 10. The first ribs 13 are uniformly distributed on the outer surface 11 at a same distance from each other and insure an optimal isolation of an enveloped conduit or of a surrounded cable. As shown in FIG. 1, the tooth-shaped first ribs 13 provide for engagement of adjacent fireproof hoses, with ribs 13 of one fireproof hose 10 engaging in grooves between the ribs 13 of another fireproof hose 10 and vice versa. This makes possible a compact grouping of several fireproof hoses 10. The inner surface 12 of the fireproof hoses 10 is not profiled. A fireproof hose 10 can be passed and secured in a leadthrough, e.g., a hole in a constructional component alone or in a group.

The two ends of a fireproof hose 10, which open toward the inner space 16, can be reversibly closed with deformable plugs 15 of a permanently elastic material such as fireproof plastic mass, so that a flue gastight closing is also insured with an empty fireproof hose 10. The plugs 15 can be removed before passing a cable or a conduit through the fireproof hose 10 and can be used again, e.g., as a sealing mass for closing, if needed, a gap between the fireproof hose 10 and a conduit or a cable.

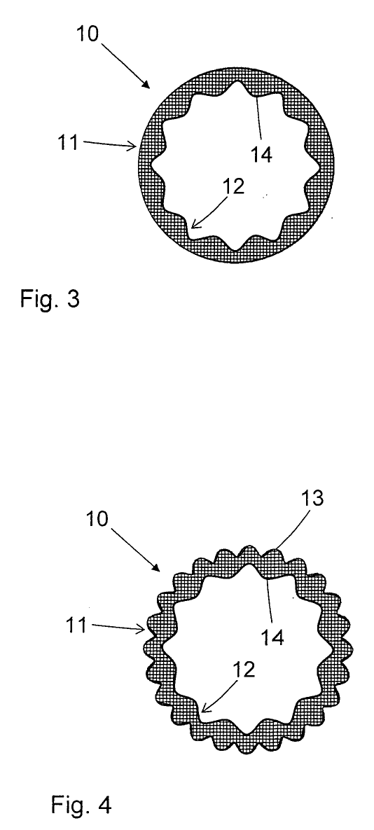

A fireproof hose 10, which is shown in FIG. 3 differs from the fireproof hose 10 described with reference to FIGS. 1-2, in that the profile in form of second ribs 14 is provided on the inner surface 12. The second ribs 14 likewise improve the thermal characteristics of the fireproof hose 10.

A fireproof hose 10 shown in FIG. 4, differs from those described previously in that a rib profile is provided on both the outer surface 11 and the inner surface 12 in form, respectively, of the first ribs 13 and the second ribs 14. Thereby, the thermal characteristics of the fireproof hose 10 are improved even further. In the embodiment shown in FIG. 4, the first ribs 13 and the second ribs 14 have a somewhat rounded outer contour.

Though the present invention was shown and described with references to the preferred embodiments, such are merely illustrative of the present invention and are not to be construed as a limitation thereof and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

What is claimed is:

1. A fireproof hose (10) for passing conduits or cables through a constructional element and formed at least partially of an elastic and intumescent material, comprising outer surface (11) and inner surface (12) extending in a longitudinal direction (L); and a profile provided on at least one of the outer surface (11) and the inner surface (12).

2. A fireproof hose according to claim 1, wherein the profile is formed by a plurality of ribs (13, 14) extending in the longitudinal direction (L).

3. A fireproof hose according to claim 2, wherein the ribs (13, 14) extend parallel to each other and are equidistantly spaced from each other.

4. A fireproof hose according to claim 2, wherein the ribs (13) are formed on the outer surface (11) of the hose.

5. A fireproof hose according to claim 2, wherein the ribs (14) are formed on the inner surface (12) of the hose.

6. A fireproof hose according to claim 2, wherein the ribs are formed on both the outer surface (11) and the inner surface (12) of the hose.

7. A fireproof hose according to claim 2, wherein the ribs (13, 14) have a tooth-shaped contour.
